(19) United States
(12) Patent Application Publication
(10) Pub. No.: US 2002/0078207 A1
(43) Pub. Date: Jun. 20, 2002

(54) Online system recovery system, method and program

(75) Inventor: Koji Iwamoto, Yokohama (JP)

Correspondence Address: McDermott, Will & Emery, 600, 13th Street, N.W., Washington, DC, 20005-3096, US

(73) Assignee: Hitachi, Ltd.

(21) Appl. No.: 10/012,437

(22) Filed: Dec. 12, 2001

(30) Foreign Application Priority Data
Dec. 15, 2000 (JP) 2000-381623

(51) Int. Cl. G06F 15/173

(52) U.S. Cl. 709/226

(57) ABSTRACT

An online system recovery method by which, when an error takes place in an active online system, changeover is carried out to a stand-by online system to continue operation. The method includes the steps of transferring log information about a reference history indicative of a history of reference operation carried out in the active online system and about an update history indicative of a history of update operation to the stand-by online system; performing tracing operation to make contents of an I/O buffer in the stand-by online system to coincide with contents of an I/O buffer in the active online system according to the transferred log information; and monitoring an operating state of the active online system now executing transaction operation and, when an error in the active online system was detected, causing the stand-by online system to continue the transaction operation.

### BACKGROUND OF THE INVENTION

The present invention relates to an online processing system necessary for high-speed recovering operation due to a system down and more particularly, to a technique which can be effectively applied to an online processing system such as an online database system where a lot of update transactions take place.

In a conventional general method for recovering an online system, for the purpose of recovery operation when an active online system is stopped by an error, log information as history information necessary for system recovery is previously stored in a log file on an external storage in the active online system so that, when an error takes place in the active online system, a stand-by online system reads out the log information and executes operations necessary therefor.

One of such speeding-up techniques is known as disclosed in, e.g., JP-A-62-57030. In summary of the disclosed invention, a stand-by online system previously reads out log information on an external storage shared by host computers prior to generation of an error and traces its operation prior to a system down of an active online system, thereby reducing the amount of log information to be read out when the error took place.

As disclosed in JP-A-2-77943, further, it is also known that log information is stored in a log file on an external storage shared by host computers in an active online system and also stored in an extension storage shared by the host computers, so that, in system recovery operation by a stand-by online system after an error took place in an active online system, reading of the log information from the external storage can be avoided by reading the log information from the extension storage.

As disclosed in JP-A-10-49418, furthermore, a method is also known wherein a log file of an active online system is transferred to a stand-by online system via communication line so that, before a changeover due to an error is carried out, a stand-by online system performs tracing operation, to thereby speed up the system recovery after the error occurrence.

In the technique disclosed in JP-A-62-57030, however, it is required, after occurrence of a changeover to the stand-by online system caused by the error, to input the log information subsequent to a checkpoint from the log file on the extension storage and thus the system must read an enormous amount of log information depending on the checkpoint interval, which results in a major cause of blocking realization of high-speed system recovery. When the checkpoint interval is made narrow in order to reduce the amount of log information to be read after occurrence of the changeover caused by the error, on the other hand, this will involve an increase in the overhead of the active online system.

The technique disclosed in JP-A-2-77943 can increase the reading speed of the log information, but, as in the technique disclosed in JP-A-62-57030, it is required to read log information subsequent to a checkpoint after occurrence of a changeover to the stand-by online system caused by an error. And the system must read an enormous amount of log information depending on the checkpoint interval, which leads to a major cause of blocking realization of high-speed system recovery. When the checkpoint interval is made narrow in order to reduce the amount of log information after occurrence of the changeover due to the error, this also involves another problem with an increased overhead of the active online system.

In the technique disclosed in JP-A-10-49418, the log information of the active online system is transferred to the stand-by online system via communication line so that the stand-by online system performs tracing operation prior to occurrence of changeover caused by the error. However, since the tracing operation is carried out with use of only the log information of an update history, a result of reference operation such as reference to an index by the active online system cannot be reflected on the storage of the stand-by online system. Thus when the changeover caused by the error took place, the efficiency of the reference operation such as index search will be disadvantageously decreased. Further, there is another problem that, since the external storage of the log file, database, etc. is not shared, the external storage must have a capacity corresponding to twice the capacity of the external storage not shared. In addition, once redundant configuration collapses due to an error in the stand-by online system side, it is required to temporarily stop the execution of transaction to recover the redundant configuration normal. For this reason, there is a problem that the system cannot operate continuously for 24 hours and 365 days.

### SUMMARY OF THE INVENTION

It is therefore an object of the present invention to provide a technique which can solve the above problems in the prior art and can change an active online system to a stand-by online system at a high speed when an error took place in the active online system.

Another object of the present invention is to provide a technique which can lighten a transfer load of log information to coincide contents of an I/O buffer within a stand-by online system with contents of an I/O buffer within an active online system.

A further object of the present invention is to provide a technique which, when a stand-by online system was re-operated after error occurrence or maintenance, can reestablish a hot standby state without affecting execution of transaction operation of an active online system.

In accordance with an online processing system of the present invention, when an error took place in an active online system, a stand-by online system continuously performs transaction operation of the active online system by changing the active online system to the stand-by online system. That is, when the error took place in the active online system, since contents of an I/O buffer of the active online system is previously made to coincide with contents of an I/O buffer of the stand-by online system, the stand-by online system can continuously perform the transaction operation with use of the I/O buffer of the stand-by online system.

In accordance with the present invention, log information about a reference history indicative of a history of reference operation and about an update history indicative of a history of update operation carried out in an active online system during operation of the active system is transferred to a stand-by online system. The stand-by online system, when receiving the log information, performs operations corresponding to the reference and update operations carried out in the I/O buffer of the active online system over the I/O buffer of the stand-by online system on the basis of the transferred log information. In other words, the contents of the I/O buffer of the stand-by online system is made to coincide with the contents of the I/O buffer of the active online system. That is, the stand-by online system performs tracing operation.

Further, the stand-by online system monitors an operating state of the active online system during tracing operation of the active system, and when detecting an error in the active system, the stand-by online system continues the tracing operation with use of the I/O buffer after subjected to tracing operation. In accordance with the present invention, as mentioned above, there can be implemented a method for recovering an online system with an active online system having a small overhead, while eliminating the need for input of log information from a log file on an external storage after an error caused the active online system to be switched to a stand-by online system.

As has been mentioned above, in the online processing system of the present invention, when an error was generated in an active online system, the transaction operation of the stand-by online system can be continued with use of the I/O buffer of the stand-by online system, the contents of which is previously made to coincide with the contents Of the I/O buffer of the active online system. Thus it is possible, when an error took place in the active online system, to change the active online system to the stand-by online system at a high speed.

### BRIEF DESCRIPTION OF THE DRAWINGS

FIG. 1 shows an example of a schematic arrangement of an online processing system in accordance with an embodiment;

FIG. 2 is a flowchart for explaining an example of a processing procedure of an active online system 12 and a stand-by online system 22 in the embodiment;

FIG. 3 is a flowchart for explaining an example of a processing procedure of business transaction operation in the embodiment;

FIG. 4 is a flowchart for explaining an example of a processing procedure of buffering operation of log information in the embodiment;

FIG. 5 is a flowchart for explaining an example of a processing procedure of forced output operation of a not-outputted log in the embodiment; and

FIG. 6 is a flowchart for explaining an example of a processing procedure of tracing operation in the embodiment.

### DESCRIPTION OF THE EMBODIMENTS

Explanation will be made as to an online processing system in accordance with an embodiment of the invention wherein, when an error took place in an active online system now performing transaction operation, the active system is changed to a stand-by online system to continue the transaction operation.

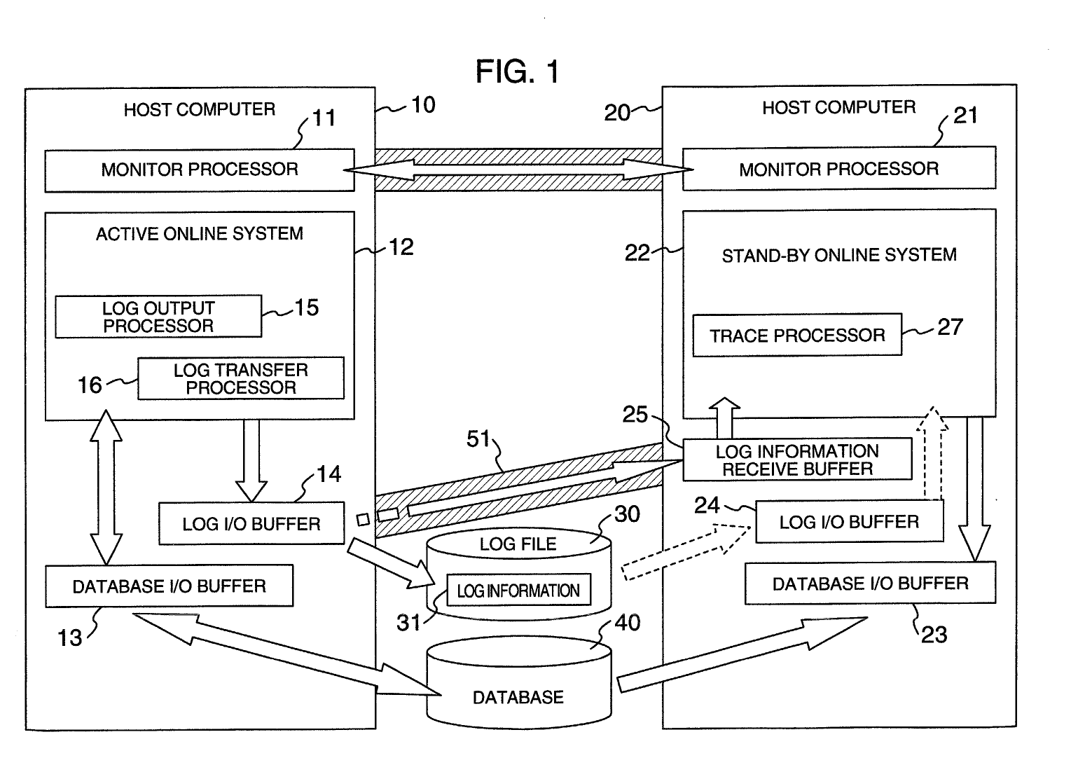

FIG. 1 shows a schematic arrangement of an online processing system in accordance with an embodiment of the invention. As shown in FIG. 1, a host computer 10 in the present embodiment has a monitor processor 11, a log output processor 15 and a log transfer processor 16.

The monitor processor 11 monitors the operating state of a party system by exchanging a control message for mutual monitoring with a monitor processor 21 of the party system to monitor the party system. The log output processor 15 is used to output log information stored in a log I/O buffer 14 a storage shared by the active online system 12 and stand-by online system 22.

The log transfer processor 16 is provided to transfer log information about a reference history indicative of a history of reference operation carried out by the active online system 12 and about an update history indicative of a history of update operation to the stand-by online system 22.

It is assumed that a program to cause the host computer 10 to function as the log output processor 15 and log transfer processor 16 is recorded in a recording medium such as CD-ROM and stored in a magnetic disk or the like, and then loaded in a memory for its execution. In this connection, the recording medium for recording of the program may be a recording medium other than CD-ROM.

A host computer 20 has a monitor processor 21 and a trace processor 27. The monitor processor 21 acts to exchange a control message for mutual monitoring between the monitor processors 21 and 11 to monitor the operating state of the active online system 12 now executing transaction operation. When the monitor processor 21 detects an error in the active online system 12, the monitor processor 21 causes the stand-by online system 22 to continue the transaction operation with use of a database I/O buffer 23 subjected to the tracing operation.

The trace processor 27 performs the tracing operation of making the contents of the database I/O buffer 23 in the stand-by online system 22 to coincide with the contents of the database I/O buffer 13 in the active online system 12 according to the transferred log information.

It is assumed that a program for causing the host computer 20 to function as the monitor processor 21 and trace processor 27 is recorded in a recording medium such as CD-ROM, stored in a magnetic disk or the like, and then loaded in a memory for its execution. In this connection, the recording medium for recording of the program may be a recording medium other than CDROM.

The online processing system of the present embodiment includes a host computer 10 on an active online side, the monitor processor 11 on the active online side, the active online system 12 (e.g., database management system) on the active online side, the host computer 20 on a stand-by online side, the monitor processor 21 on the stand-by online side, and the stand-by online system 22 (e.g., database management system) on the stand-by online side.

A log file 30 or a database 40 is provided on a nonvolatile storage (generally, a magnetic disk unit) shared by the active online system 12 on the active online side and the stand-by online system 22 on stand-by online side.

The online processing system of the present embodiment further includes the database I/O buffer 13 to be used by the active online system 12 for record input/output, the log I/O buffer 14 to be used by the active online system 12 for input/output of the log information to/from the log file 30, the database I/O buffer 23 to be used by the stand-by online system 22 for record input/output to/from the database 40, and a log I/O buffer 24 to be used by the stand-by online system 22 for input/output of the log information to/from the log file 30.

The active online system 12 further includes the log output processor 15 for outputting the log information stored in the log I/O buffer 14 to the log file 30, and the log transfer processor 16 for transferring the log information stored in the log I/O buffer 14 to a log information receive buffer 25 of the stand-by online system 22. The stand-by online system 22 has the trace processor 27 for performing the tracing operation of the stand-by system concurrently with the tracing operation of the active online system 12 according to the transferred log information. A communication medium 50 is provided for exchange of a control message (alive message) for mutual monitoring between the monitor processors 11 and 21. A communication medium 51 is provided for transfer of the log information from the active online system 12 to the stand-by online system 22. The log I/O buffer 24 is provided to input log information 31 on the log file 30 in the stand-by online system 22.

In this connection, the communication media 50 and 51 may be physically combined into a single medium. However, for the purpose of preventing erroneous operation caused by a transfer delay of the control signal when the transfer traffic of the log information becomes high, the media are provided separately in the present embodiment.

The database I/O buffer 13, log I/O buffer 14, database I/O buffer 23, log I/O buffer 24 or log information receive buffer 25 may be single respectively. However, for the purpose of securing the performance and reliability, buffering is carried out respectively with a plurality of buffers.

The log output processor 15 and log transfer processor 16 are shown in the active online system 12 and the trace processor 27 is shown in the stand-by online system 22 in FIG. 1. However, the active online system 12 and stand-by online system 22 have the same components mounted therein and are different only in their behaviors demanded by their active or stand-by system.

Thus, after an error took place in the host computer 10 and a transaction execution authority is switched to the host computer 20 to cause the stand-by online system 22 to start the transaction service; the stand-by online system 22 is switched to the active system. And after the error of the host computer 10 is recovered, the active online system 12 is switched to the stand-by online system.

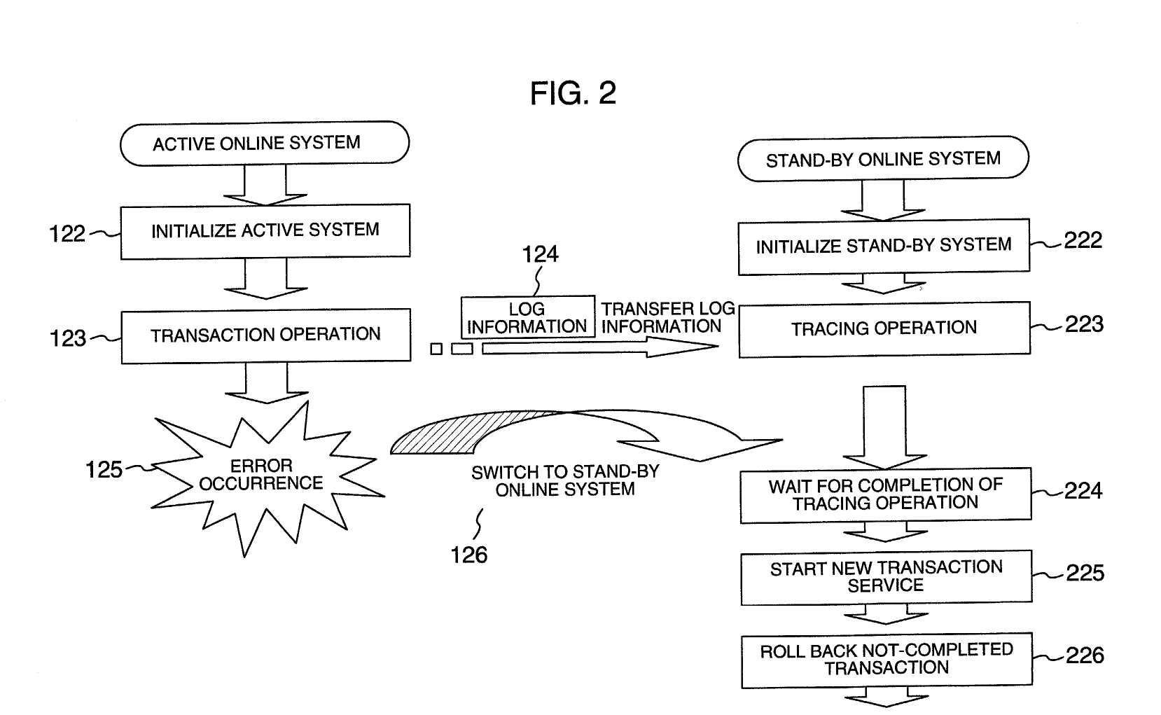

FIG. 2 is a flowchart for explaining a processing procedure of the active online system 12 and stand-by online system 22 in the present embodiment. As shown in FIG. 2, the active online system 12 in the embodiment, after started, first performs its initializing operation (step 122).

In the initializing operation, the stand-by online system 22 loads the processing program, inputs various definition information and execution parameters, creates a control table on a virtual memory, opens the database, starts a transaction execution space (also called the execution process), and further detect and stores the log information located at an end of the log file. In this example, the active online system 12 performs buffer securing, page fixing and buffer position information exchange in association with the log information transfer with the stand-by online system 22. In the online system, in addition to the above operations, establishment of communication session with another terminal, changeover preparation, etc. are included. However, since these are out of the scope of the present embodiment, these are not illustrated in FIGS. 1 and 2.

Even the stand-by online system 22, on the other hand, performs initializing operation similar to the active online system but as the stand-by system (step 222). At this point, mutual monitoring by the monitor processors 11 and 21 is started.

When the mutual monitoring is started, the active online system 12 performs business transaction operation (step 123).

When log information 124 acquired by the business transaction of the reference or update operation is transferred to the stand-by online system 22, the stand-by online system 22 traces a transaction state in the memory or record reference and update states in the database according to the log information 124 (step 223). At this time, the log file 30 and database 40 are updated by the active online system 12. Thus in the stand-by online system 22, the writing of the file and database to the external storage is not carried out, and even the tracing of the index reference state or record update state of the database is carried out only on the database I/O buffer 23 in the memory.

When an error took place in the active online system 12 (step 125), the monitor processor 11 or 21 detects the error and changes the execution authority of the business transaction to the stand-by online system 22 (step 126).

When the error is limited to the active online system 12 alone, the monitor processor 11 detects the error and informs the monitor processor 21 of it. When the error spread into the entire host computer 10 and even the monitor processor 11 cannot operate normally, the control message (alive message) from the monitor processor 11 to the monitor processor 21 is interrupted. Accordingly, the monitor processor 21 can spontaneously detect the error of the active online system 12 as the party system.

When the active online system is switched to the stand-by online system 22, the system 22 waits for completion of the tracing operation of the log information 124 not processed (step 224) and then starts a new business transaction service (step 225). Concurrently therewith, the system rolls back the transaction not completed (step 226).

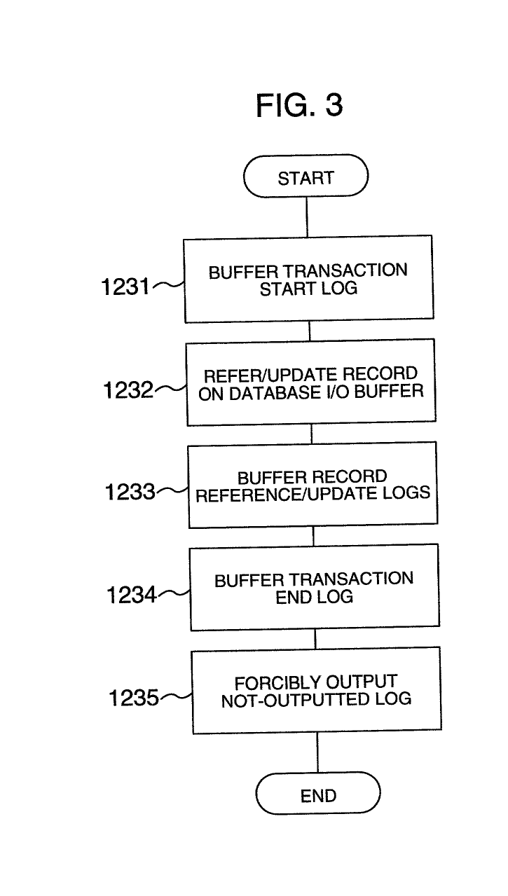

Shown in FIG. 3 is a flowchart for explaining a processing procedure of the business transaction operation in the present embodiment. Explanation will be made as to the business transaction operation of the step 123 in FIG. 2 with reference to FIG. 3.

When starting a transaction, the system buffers a log indicative of a start of the transaction in the log I/O buffer 14 (step 1231). Next the system performs record reference or update operation on the database I/O buffer 13 (step 1232) and also buffers the record reference log or update log in the log I/O buffer 14 (step 1233). After completing the reference or update of the database record in one transaction, the system buffers a transaction end log in the log I/O buffer 14 (step 1234) and forcibly outputs log information not outputted to the log file 30 (step 1235).

When the system refers to data not present in the database I/O buffer 13 in the step 1232, the system may buffer its reference log in the log I/O buffer 14 in the step 1233 to lighten a load necessary for the output or transmission of the log information.

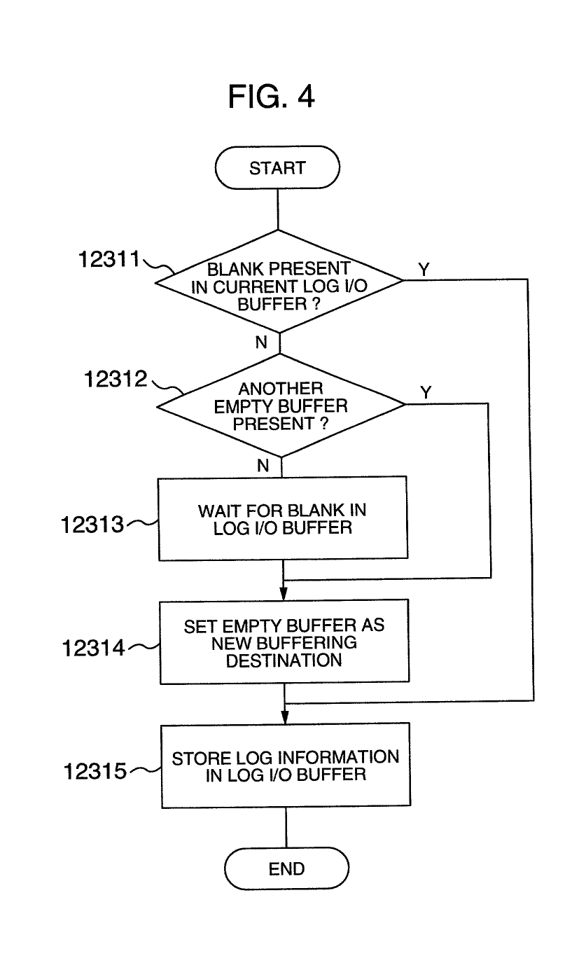

FIG. 4 is a flowchart for explaining a processing procedure of the buffering operation of the log information in the present embodiment. The buffering operation of the log information in the steps 1231, 1233 and 1234 of FIG. 3 will be explained by referring to FIG. 4.

The system first examines presence or absence of a blank area in the log I/O buffer as the current buffering destination (step 12311). In the presence of a blank area, the system stores the log information in the log I/O buffer (step 12315).

In the absence of a blank area, the system examines presence or absence of a blank area in another log I/O buffer (step 12312). If finding a blank area, then the system sets the log I/O buffer in question as a new buffering destination (step 12314), and stores the log information therein (step 12315).

When finding no single blank area in the log I/O buffer, the system continues to wait for generation of a blank area in the buffer (step 12313). In this connection, when no single blank are is present in the log I/O buffer, there is a method for securing a dynamically new log I/O buffer. However, since this causes a memory shortage and may trigger an error, this method will not be employed in the present embodiment.

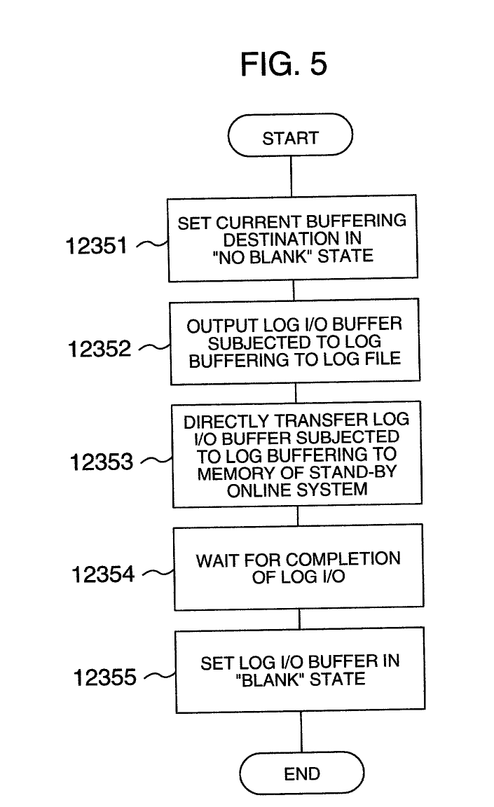

FIG. 5 is a flowchart for explaining a processing procedure of forced output operation of the log not outputted in the present embodiment. Explanation will be made as to the forced output operation of the not-outputted log in the step 1235 in FIG. 3, by referring to FIG. 5.

The system first sets the log I/O buffer currently as the buffering destination in a “no blank” state to prevent new buffering to the log I/O buffer (step 12351).

Next, the system sequentially outputs log I/O buffers not outputted yet to the log file 30 (step 12352). The output may be based on a synchronous write scheme wherein control is not returned until I/O operation to an external storage is completed, or on an asynchronous write scheme wherein control is returned before I/O operation is completed. In the present embodiment, for the purpose of minimizing the influence of the transfer operation of the log information to the stand-by online system 22 on the transaction of the active online system 12, the asynchronous write scheme is employed.

While waiting for completion of writing operation in the log file 30, the system directly writes the contents of the log I/O buffer in the step 12352 in the log information receive buffer 25 of the stand-by online system 22 via the communication medium 51 (step 12353). Information such as this write position must be previously grasped at the time of initialization and from return information at the time of previous-time write operation shown in the step 123.

When the stand-by online system 22 is not operated, the operation of the step 12353 will end unsuccessfully but the active online system 12 treats it as ended successfully. This mismatching can be solved when the system is switched to the stand-by online system 22, by reading a difference up to the latest then log of the log information receive buffer 25 from the log file 30 and by catching up with it. As a result of this solving operation, even when changeover is frequently carried out between the active and stand-by systems, the system can automatically catch up with it, as in a seesaw game.

Next the system waits for completion of the I/O operation of the step 12352 (step 12354). The system determines the log I/O buffer where both the operations of the steps 12352 and 12353 are completed as a blank buffer (step 12355).

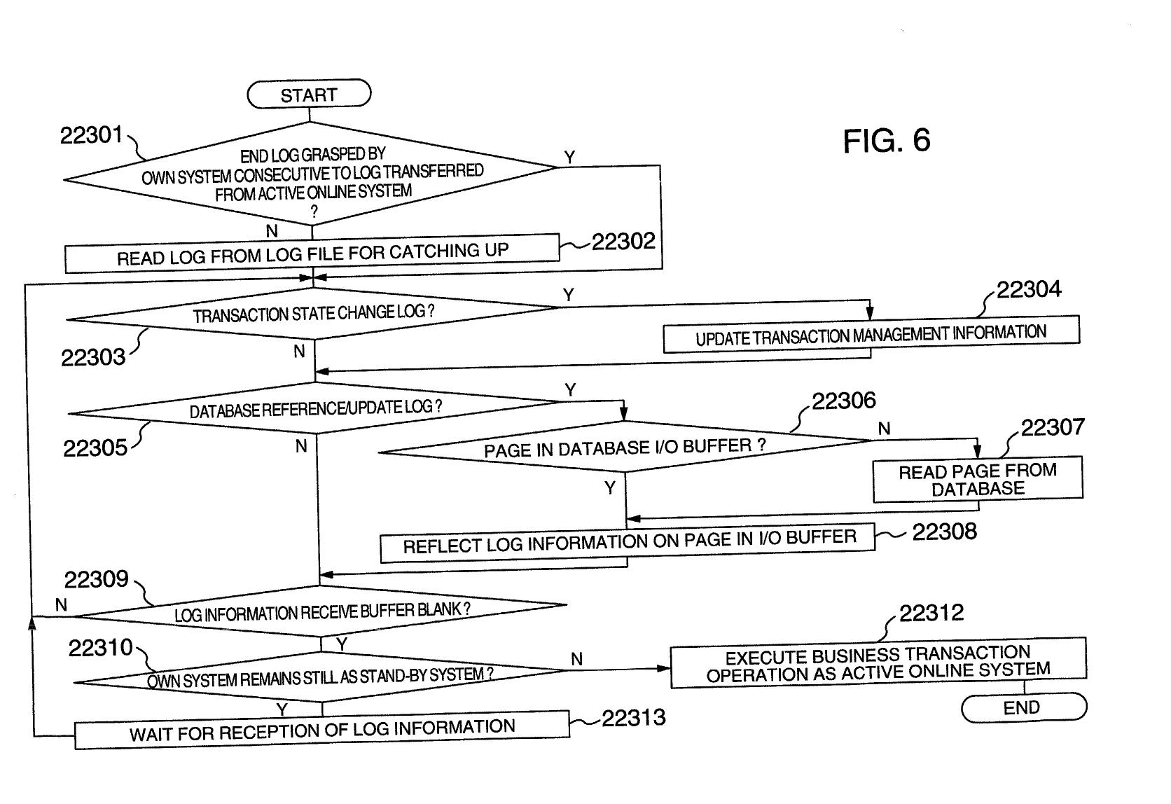

FIG. 6 is a flowchart for explaining a processing procedure of the tracing operation in the present embodiment. The tracing operation of the step 223 of FIG. 2 will be explained with reference to FIG. 6.

The system first compares log information at an end of the log file stored at the time of the initializing operation 222 of the stand-by online system 22 with log information sent to the log information receive buffer 25 (step 22301).

When the log information is discontinuous (when numbers as serial numbers of log blocks each as an assembly of generation number and log record of a log file are not consecutive and one block in the blocks is missing), the system inputs the log information 31 from the log file 30 to catch up with the time point of the log information receive buffer 25 (step 22302). A specific method for the catching-up operation is substantially the same as that in steps 22303 to 22308 to be explained later.

Next, the system sequentially examines individual log information stored in the log information receive buffer 25. And when the log is such a log as a transaction start or end log where a change of the transaction state is recorded (step 22303), the system updates management information for each transaction in the memory (step 22304).

When the log is a database record reference or update log (step 22305), the system examines presence or absence of a corresponding page in the database I/O buffer 23 (step 22306). In the absence of the page of the record in the database I/O buffer 23, the system reads the record page into the database I/O buffer 23 from the database 40 (step 22307). When the log is an update log, the system updates the record on the database I/O buffer 23 according to the contents of the update log (step 22308).

The system repeats the operations of the steps 22303 to 22308 for all log information present in the log information receive buffer 25 (step 22309).

Subsequently, the system confirms whether or not error detection is informed from the monitor processor 11 or 21 and also examines whether or not its own system remains still as the stand-by system(step 22310). If the system still remains as the stand-by system, then the system waits for reception of the log information (step 22313) and repeats the operations of the steps 22303 to 22308. When changeover to the active system is instructed by the error detection of the monitor processor 11 or 21, the system executes the business transaction operation as the active system.

As has been explained above, in accordance with the online processing system of the present invention, when an error took place in the active online system, the stand-by online system can continue the transaction operation with use of the I/O buffer of the stand-by online system, the contents of which was previously made to coincide with the contents of the I/O buffer of the active online system. Thus at the time of error occurrence in the active online system, changeover to the stand-by online system can be carried out at a high speed.

Further, in the online processing system of the present embodiment, when reference operation is carried out to data not present in the I/O buffer of the active online system, the system transfers the reference history to the stand-by online system as log information. As a result, the transfer load of the log information necessary to make the contents of the I/O buffer in the stand-by online system to coincide with the contents of the I/O buffer in the active online system can be lightened.

In the online processing system of the present embodiment, in addition, when the log information subjected to the tracing operation is discontinuous to the log information transferred from the active online system, the system reads out discontinuous log information therebetween from the storage and performs the catch-up operation over the I/O buffer in the stand-by online system. Therefore, when the stand-by online system had an error or was reoperated after its maintenance, the system can again establish the hot stand-by state while not affecting the execution of the transaction operation of the active online system.

In accordance with the present invention, when an error took place in the active online system, the system can continue the transaction operation of the stand-by online system with use of the I/O buffer of the stand-by online system, the contents of which was previously made to coincide with the contents of the I/O buffer of the active online system. As a result, when an error took place in the active online system, changeover to the stand-by online system can be realized at a high speed.

It will be further understood by those skilled in the art that the foregoing description has been made on embodiments of the invention and that various changes and modifications may be made in the invention without departing from the spirit and scope the appended claims.

What is claimed is:

1. An online system recovery method by which, when an error takes place in an active online system, changeover is carried out to a stand-by online system to continue operation, comprising the steps of:
transferring log information about a reference history indicative of a history of reference operation carried out in the active online system and about an update history indicative of a history of update operation to the stand-by online system;
performing tracing operation to make contents of an I/O buffer in the stand-by online system to coincide with contents of an I/O buffer in the active online system according to said transferred log information; and
monitoring an operating state of the active online system now executing transaction operation and, when an error in the active online system was detected, causing the stand-by online system to continue the transaction operation.

2. An online system recovery method as set forth in claim 1, wherein the reference history transferred to the stand-by online system as said log information indicates a history of reference operation to data not present in an I/O buffer of the active online system.

3. An online system recovery method as set forth in claim 1, further comprising a step of outputting said log information to a storage shared by the active and stand-by online systems and a step, when the log information subjected to said tracing operation is not successive to the log information transferred from the active online system, of reading out log information therebetween from said storage and making contents of the I/O buffer in the stand-by online system to coincide with contents of an I/O buffer in the active online system according to the read-out log information and said transferred log information.

4. An online system recovery method as set forth in claim 2, further comprising a step of outputting said log information to a storage shared by the active and stand-by online systems and a step, when the log information subjected to said tracing operation is not successive to the log information transferred from the active online system, of reading out log information therebetween from said storage and making contents of the I/O buffer in the stand-by online system to coincide with contents of an I/O buffer in the active online system according to the read-out log information and said transferred log information.

5. An online processing system wherein, when an error takes place in an active online system, changeover is carried out to a stand-by online system to continue operation, comprising:
a log transfer processor for transferring log information about a reference history indicative of a history of reference operation carried out by the active online system and about an update history indicative of a history of update operation to the stand-by online system;
a trace processor for performing tracing operation to make contents of an I/O buffer in the stand-by online system to coincide with contents of an I/O buffer in the active online system according to said transferred log information; and
a monitor processor for monitoring an operating state of the active online system now executing transaction operation and, when detecting an error in the active online system, for causing the stand-by online system to continue said transaction operation with use of the I/O buffer subjected to said tracing operation.

6. An online processing system as set forth in claim 5, wherein the reference history transferred to the stand-by online system as said log information indicates a history of reference operation to data not present in the I/O buffer of the active online system.

7. An online processing system as set forth in claim 5, further comprising a log information output processor for outputting said log information to a storage shared by the active and stand-by online systems, and a trace processor, when the log information subjected to said tracing operation is not consecutive to the log information transferred from the active online system, for reading out log information therebetween from said storage and making contents of an I/O buffer in the stand-by online system to coincide with contents of an I/O buffer in the active online system according to the read-out log information and said transferred log information.

8. A computer-recordable recording medium having a program recorded therein, said program functioning to cause a computer that has read the program thereby to function as an online processing system which is now performing tracing operation and, when an error took place in an active online system, which switches the active system to a stand-by online system to continue the tracing operation, said computer functioning as a log transfer processor for transferring log information about a reference history indicative of a history of reference operation carried out by the active online system and about an update history indicative of a history of update operation, a trace processor for performing tracing operation of making contents of an I/O buffer in the stand-by online system to coincide with contents of an I/O buffer in the active online system, and a monitor processor for monitoring an operating state of the active online system now performing tracing operation and, when detecting an error in the active online system, causing the stand-by online system to continue said tracing operation with use of the I/O buffer subjected to said tracing operation.

9. A program for implementing an online system recovery method, when an error took place in an active online system now performing tracing operation, for switching the active online system to a stand-by online system to continue the tracing operation, said program comprising the steps of:
transferring log information about a reference history indicative of a history of reference operation carried out by the active online system and about an update history indicative of a history of update operation to the stand-by online system;
a performing tracing operation of making contents of an I/O buffer in the stand-by online system to coincide with contents of an I/O buffer in the active online system according to said transferred log information; and
monitoring an operating state of the active online system now performing the tracing operation and, when detecting an error in the active online system, causing the stand-by online system to continue said tracing operation with use of the I/O buffer subjected to said tracing operation.

10. A program for implementing an online system recovery method as set forth in claim 9, wherein the reference history transferred to the stand-by online system as said log information indicates a history of reference operation to data not present in the I/O buffer in the active online system.

11. A program for implementing an online system recovery method as set forth in claim 10, further comprising a step of outputting said log information to a storage shared by the active and stand-by online systems, and a step, when the log information subjected to said tracing operation is not consecutive to the log information transferred from the active online system, of reading out log information therebetween from said storage, of making contents of an I/O buffer in the stand-by online system to coincide with contents of an I/O buffer in the active online system according to said read-out log information and said transferred log information.
